(19) United States
(12) Patent Application Publication
(10) Pub. No.: US 2014/0053722 A1
(43) Pub. Date: Feb. 27, 2014

(54) MACHINE TOOL MOUNTED MIST COLLECTOR WITH AUTOMATIC CONTROL

(71) Applicant: Paul Cacciotti, Troy, NY (US)

(72) Inventor: Paul Cacciotti, Troy, NY (US)

(21) Appl. No.: 13/972,856

(22) Filed: Aug. 21, 2013

Related U.S. Application Data
(60) Provisional application No. 61/691,672, filed on Aug. 21, 2012.

(51) Int. Cl. B01D 46/42

(52) U.S. Cl. CPC B01D 46/4245
USPC 95/1; 96/397

(57) ABSTRACT

An automatic control for a system for removing cooling liquid from a mist. The automatic control includes a power input configured to receive electrical power and a power output configured to output electrical power to a mist collector. The automatic control also includes a sensor configured to determine whether a coolant pump is supplying cooling liquid and a switch configured to send electrical power to the mist collector via the power output when the coolant pump is supplying cooling liquid.

### CROSS-REFERENCE TO RELATED APPLICATIONS

This application claims the benefit of and priority to U.S. Provisional Patent Application Ser. No. 61/691,672 filed on Aug. 21, 2012, which application is incorporated herein by reference in its entirety.

### BACKGROUND OF THE INVENTION

Cooling liquid is commonly used with machine tools. These tools may produce a high rate of motion or rotation. As the tool interacts with a work material, the high rate of motion may lead to high amounts of frictional heating. This heating may damage the tool, the work material or both. To prevent his damage a cooling liquid is often circulated over the tool and work material. The circulating cooling liquid removes the heat, preventing unwanted damage.

Nevertheless, there are a number of drawbacks associated with the use of cooling liquid. In particular, the motion of the tool tends to scatter the cooling liquid. I.e., the stream of cooling liquid is disrupted and broken up into droplets. This can result in cooling liquid causing a large mess in the immediate area.

In addition, it can make it more difficult to recover the cooling liquid. I.e., the cooling liquid is recirculated over and over, repeatedly dissipating the frictional heat. However, the disruption of the cooling liquid stream can result in loss of cooling liquid. This can lead to a loss of efficiency as the cooling liquid may not be given sufficient time to be cooled before being recirculated. Further, it can lead to greater expense as the cooling liquid needs to be replaced.

Moreover, the scattered droplets may be suspended in the air. These droplets can form a mist if enough droplets are formed. This cooling mist can enter air intakes of the machine tool or other machines in the nearby area, which can foul the operation of the machines. In addition, it can be inhaled by workers in the immediate area, causing respiratory or other health problems.

Accordingly, there is a need in the art for a system that can remove the cooling liquid droplets from the mist. In addition, there is a need in the art for the system to collect the cooling liquid. Further, there is a need in the art for the system to allow the cooling liquid to be recirculated.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an automatic control for a system for removing cooling liquid from a mist. The automatic control includes a power input configured to receive electrical power and a power output configured to output electrical power to a mist collector. The automatic control also includes a sensor configured to determine whether a coolant pump is supplying cooling liquid and a switch configured to send electrical power to the mist collector via the power output when the coolant pump is supplying cooling liquid.

Another example embodiment includes a system for removing cooling liquid from a mist. The system includes a housing and a fan, where the fan is configured to move air through the system. The system also includes an intake, where the intake is configured to allow a cooling mist from the exterior of the housing to enter the interior of the housing, where the cooling mist includes cooling liquid droplets suspended in air. The system further includes a mist filter. The mist filter is configured to remove the cooling liquid from the mist. The mist filter includes a first mist filter, where the first mist filter is configured to remove a portion of the cooling liquid from the cooling mist, and a second mist filter, where the second mist filter is configured to remove the majority of the remaining cooling liquid from the cooling mist. The system additionally includes an air filter. The air filter includes a first air filter, where the first air filter is configured to remove a portion of pollutants from the demisted air. The air filter also includes a second air filter, where the second air filter is configured to remove a portion of the pollutants not removed by the first air filter. The system also includes an exhaust, where the exhaust is configured to output the demisted air. The system further includes an automatic control, wherein the automatic control is configured to control the operation of the fan. The automatic control includes a power input configured to receive electrical power and a power output configured to output electrical power to the mist collector. The automatic control also includes a sensor configured to determine whether a coolant pump is supplying cooling liquid and a switch configured to send electrical power to the mist collector via the power output when the coolant pump is supplying cooling liquid.

Another example embodiment includes a method for removing cooling liquid from a cooling mist. The method includes controlling the operation of the system using an automatic control. The automatic control includes a power input configured to receive electrical power and a power output configured to output electrical power to the mist collector. The automatic control also includes a sensor configured to determine whether a coolant pump is supplying cooling liquid and a switch configured to send electrical power to the mist collector via the power output when the coolant pump is supplying cooling liquid. The method moreover includes receiving a cooling mist, where the cooling mist includes cooling liquid droplets suspended in air. The method also includes passing the cooling mist through a mist filter, where the mist filter removes a portion of the cooling liquid droplets from the air. The method further includes passing the demisted air through an air filter, where the air filter removes a portion of a desired pollutant from the demisted air. The method additionally includes outputting the demisted and filtered air.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a front view of a mist collector;

FIG. 1B illustrates a side view of the mist collector;

FIG. 2 illustrates a cross-sectional view of the mist collector through the line A-A of FIG. 1A;

FIG. 3 illustrates an example of an automatic control 300 for a mist collector;

FIG. 4 is a flow chart illustrating a method 400 of controlling a mist collector;

FIG. 5 illustrates an example of a baffle filter;

FIG. 6 illustrates an expanded view of an example of a mesh filter;

FIG. 7 illustrates an example of an air filter; and

FIG. 8 is a flow chart illustrating a method of removing a cooling liquid from a mist.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

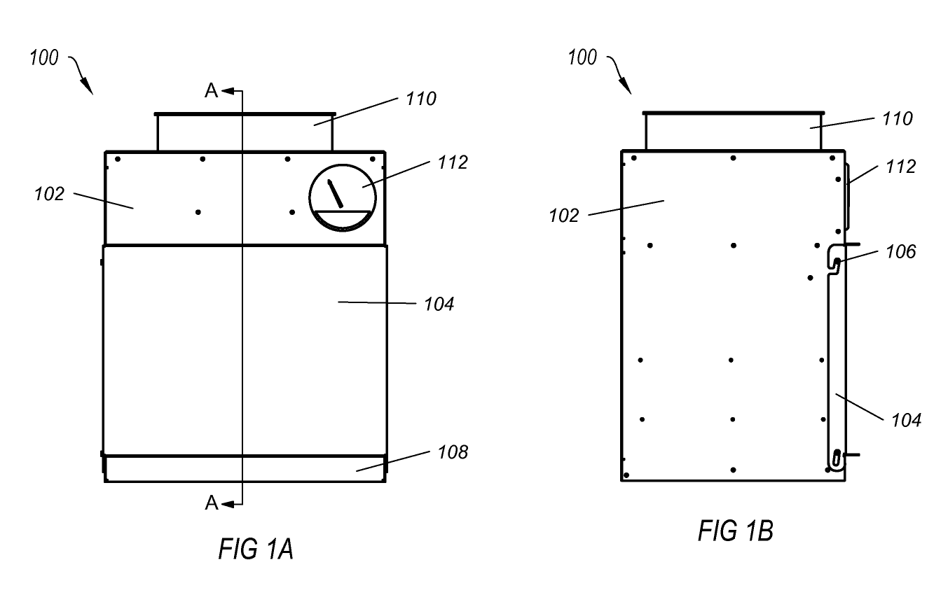

FIGS. 1A and 1B illustrate an example of a mist collector 100. FIG. 1A illustrates a front view of the mist collector 100; and FIG. 1B illustrates a side view of the mist collector 100. The mist collector 100 can collect cooling liquid from a cooling mist. In particular, many tools use a cooling liquid that is applied to either the work surface or some portion of the tool. The cooling liquid is configured to remove the heat caused by friction during the machining process. The machining process can, in turn, throw droplets of the cooling liquid into the air, creating a mist. For example, the cooling liquid can include water, antifreeze, oils, water soluble oil or any other desired cooling liquid.

FIGS. 1A and 1B show that the mist collector 100 can include a housing 102. The housing 102 can surround and protect the other elements of the exercise system 100. In particular, the housing 102 can be configured to ensure that the other elements of the exercise system 100 are in the proper position relative to one another.

FIGS. 1A and 1B also show that the mist collector 100 can include a door 104. The door 104 can allow access to a portion of the interior of the housing 102. I.e., the door 104 can include a portion of the housing 102 which is movable or removable and allows a user to access the interior of the housing 102.

FIGS. 1A and 1B further show that mist collector 100 can include an attachment 106. The attachment 106 is configured to attach the door 104 to the housing 102. In particular, the attachment 106 can seal the connection between the door 104 and the housing 102, preventing unwanted air flow through the door 104 during operation. For example the attachment 106 can include one or more fasteners, such as screws, magnets, angled slots and pins or any other desired fastener. Additionally or alternatively, the attachment 106 can include one or more hinges which allow the door 104 to mover relative to the housing 102.

FIGS. 1A and 1B additionally show that the mist collector 100 can include an intake 108. The intake 108 can allow cooling mist to enter the housing 102. I.e., the intake 108 can pull cooling mist into the housing, where the cooling liquid will be removed from the cooling mist, as discussed below. Additionally or alternatively, the collected cooling liquid can pass back through the intake 108 to be used by the tool again.

FIGS. 1A and 1B also show that the mist collector 100 can include an exhaust 110. The exhaust 110 can allow clean air to exit the mist collector 100. I.e., the mist collector 100 will take in cooling mist through the intake 108, and pump out clean air, with the cooling liquid removed, through the exhaust 110. The exhaust 110 can connect to the machine tool, can be vented to the outdoors, or can be vented into the tool room, as desired by the user.

FIGS. 1A and 1B further show that the mist collector 100 can include a gauge 112. The gauge 112 can indicate the current state of one or more components within the mist collector 100. I.e., the gauge 112 can indicate to a user whether one or more components of the mist collector 112 are operating correctly and/or need to be replaced. For example, the gauge 112 can include a magnehelic gauge. A magnehelic gauge is a device used to measure positive, negative and differential pressures. A magnehelic gauge includes two air ports separated by a diaphragm. Pressure acting on the diaphragm of the gauge moves the indicating pointer. The movement of the pointer is relayed and amplified through a magnetic linkage. As the filter portions of the mist collector 100 become clogged, the pressure differential can increase. When the gauge measures a high enough pressure differential, one or more of the filters may need to be replaced.

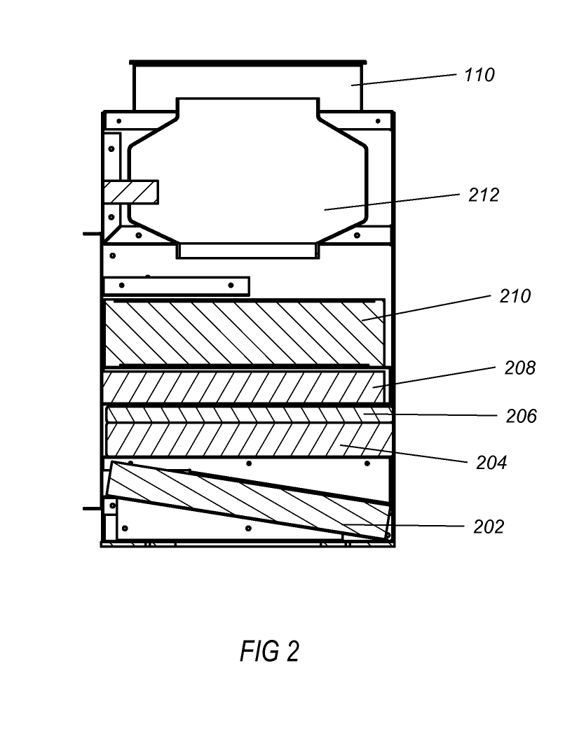

FIG. 2 illustrates a cross-sectional view of the mist collector 100 through the line A-A of FIG. 1A. The mist collector 100 is configured to receive air that contains cooling mist. The mist collector 100 can remove the cooling liquid from the cooling mist, which can be returned to the machine tool, and any other pollutants in the air. The mist collector 100 can then exhaust clean air.

FIG. 2 shows that the mist collector 100 can include a first mist filter 202. The first mist filter 202 can include any desired material. For example, the first mist filter 202 can include plastic or metal. The first mist filter 202 can collect larger mist particles. I.e., the first mist filter 202 can collect large droplets from the cooling mist. For example, the first mist filter 202 can include a baffle filter. A baffle filter can include a series of baffles that the cooling mist must pass through. Because there is not a straight line through the filter, larger particles are unable to make the turns required by the air flow and collects on the baffles.

The first mist filter 202 can be inclined relative to a horizontal position. Inclining the first mist filter 202 can allow the larger droplets which have been collected to travel down the filter, where they are collected and reused as cooling liquid for the machine tool.

FIG. 2 also shows that the mist collector 100 can include a second mist filter 204. The second mist filter 204 can include any desired material. For example, the second mist filter 204 can include plastic or metal. The second mist filter can collect smaller mist particles. I.e., particles which are small enough to remain in the air flow and pass through the first mist filter 202 are collected by the second mist filter 204. The second mist filter 204 can be inclined similar to the first mist filter 202, allowing the collected cooling liquid to drain. Additionally or alternatively, the second mist filter 204 can be horizontal. Any droplets collected can form drops where collected which are allowed to drip onto the first mist filter 202 then collected and returned to the machine tool.

The second mist filter 204 can include any filter configured to receive smaller mist droplets. For example, the second mist filter 204 can include a mesh filter. A mesh filter can include one or more mesh layers. Mesh consists of semi-permeable barrier made of connected strands of material. I.e., mesh includes material with very small openings. As the cooling mist passes through the mesh filter, the cooling mist collects on the strands of material. Mesh layers can be offset relative to one another, eliminating straight lines of air flow. The more mesh layers present, the more droplets collected and the less droplets allowed to pass through the mesh filter; however, more mesh layers decrease the air flow through the mesh filter increasing the required pressure to circulate the cooling mist.

FIG. 2 further shows that the mist collector 100 can include a pre-filter 206. The pre-filter 206 can absorb any remaining cooling fluid within the air. I.e., the pre-filter 206 can be configured to ensure that any non-recoverable cooling fluid is also removed from the air. For example, the pre-filter 206 can include cloth or other material which will absorb the cooling fluid. For example, the pre-filter 206 can include a pad made of cotton, polyester or any other desired material.

FIG. 2 further shows that the mist collector 100 can include a first air filter 208. The first air filter 208 can be configured to remove one or more pollutants from the air. For example, the first air filter 208 can include a carbon filter. Carbon filtering is a method of filtering that uses a piece of activated carbon to remove contaminants and impurities, utilizing chemical adsorption. Activated carbon, also called activated charcoal, activated coal or carbo activatus, is a form of carbon that has been processed to make it extremely porous and thus to have a very large surface area available for adsorption. One pound (454 g) of activated carbon contains a surface area of approximately 100 acres. A carbon filter can be utilized to remove odors from the demisted air.

FIG. 2 additionally shows that the mist collector 100 can include a second air filter 210. The second air filter 210 can remove additional air pollutants. For example, the second air filter 210 can include a particulate air filter. A particulate air filter is a device composed of fibrous materials which removes solid particulates such as dust, pollen, mold, and bacteria from the air. A particulate air filter can include foam, pleated paper, cotton, cloth or spun fiberglass filter elements. Additionally or alternatively, the second air filter 210 can include an ionizing filter. An ionizing filter, or ioniser, uses fibers or elements with a static electric charge, which attract dust particles.

One of skill in the art will appreciate that the first air filter and the second air filter can be combined with one another. For example, an ionizing filter may be able to remove both odor particles and larger particles from the air. Additionally or alternatively, the number of filters may be increased as needed to remove other pollutants or particles from the air.

FIG. 2 also shows that the mist collector 100 can include a fan 212. A fan is a machine used to create flow within the air. I.e., the fan 212 creates an air flow that draws cooling mist into the mist collector 100 through the first mist filter 202, the second mist filter 204, the first air filter 208, the second air filter 210 and out the exhaust 110.

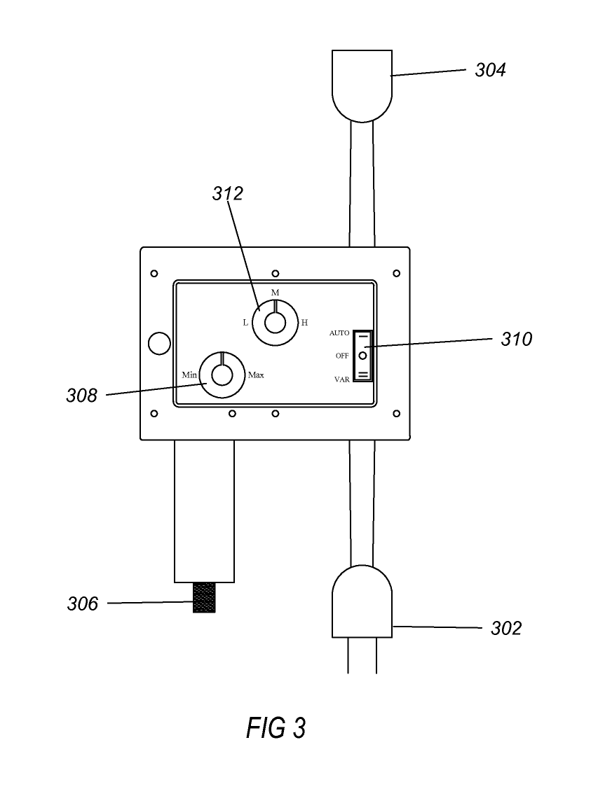

FIG. 3 illustrates an example of an automatic control 300 for a mist collector. For example, the mist collector can include the mist collector 100 of FIGS. 1 and 2. The automatic control 300 can be built into the mist collector or can be an add-on. I.e., the automatic control 300 can be used to control the power directed to the mist collector, controlling its operation. The automatic control can include and desired control feature. For example, the automatic control 300 can determine the presence of cooling mist and operate the mist collector accordingly. Additionally or alternatively, the automatic control 300 can include a timer or sensor that determines the operation of the mist collector.

FIG. 3 shows that the automatic control 300 can include a power input 302 and power output 304. The power input 302 and the power output 304 can allow the automatic control 300 to control the power flow to the mist collector. I.e., the power input 302 and power output 304 can be placed in-line with the power of the mist collector. For example, the power input 302 and the power output 304 can include a plug and socket respectively. I.e., the power input 302 can be plugged into an outlet and the mist collector can be plugged into the power output 304.

FIG. 3 also shows that the automatic control 300 can include a sensor 306. The sensor 306 can be connected to a machine tool and the sensor 306 can measure a parameter to determine if the mist collector should remain in operation. I.e., the sensor can include a switch configured to send electrical power to the mist collector via the power output when the coolant pump is supplying cooling liquid. For example, the sensor 306 can include a coolant pressure sensor which measures the flow of coolant to the machine tool or can include a coolant flow sensor. This can allow the automatic control 300 to operate when coolant is flowing and mist controller operation is required. Additionally or alternatively, the sensor 306 can include a relay sensor controlled by the coolant pump voltage or current.

Additionally or alternatively, the sensor 306 can include a door sensor. When the door is closed, the automatic control turns on the mist collector. When the door is opened, the automatic control turns on the mist collector begins at high speed for a predetermined interval and the ceases operation, as described below. One of skill in the art will appreciate that the sensor 306 can include additional sensors for safety or operational purposes. For example, the sensor 306 can include a connection that stops power to the mist collector if an emergency switch on the attached machine tool is activated.

FIG. 3 moreover shows that the automatic control 300 can include a timer 308. The timer 308 can allow or prevent operation of the mist collector for a predetermined amount of time. For example, the timer 308 can ensure that the mist collector continues to run for a specified time after the coolant pump or machine tool ceases operation. E.g., after the coolant pump is turned off, either manually or in concert with the machine tool, the timer 308 can continue operation of the mist collector for a specified amount of time. The specified amount of time can be preprogramed or a switch can allow a user to change the specified amount of time.

FIG. 3 further shows that the automatic control 300 can include a mode switch 310. The mode switch 310 can allow a user to control the operation of the automatic control 300. For example, the user can select between manual mode, where the user controls the mist collector fan speed, automatic mode, where the automatic control 300 controls the mist collector fan speed and power off.

FIG. 3 additionally shows that the automatic control 300 can include a variable speed adjust 312. The variable speed adjust 312 can allow the user to control the mist collector fan speed when the mode switch 310 is in the manual control position. I.e., the variable speed adjust can allow a user to change the speed of the mist collector when so desired.

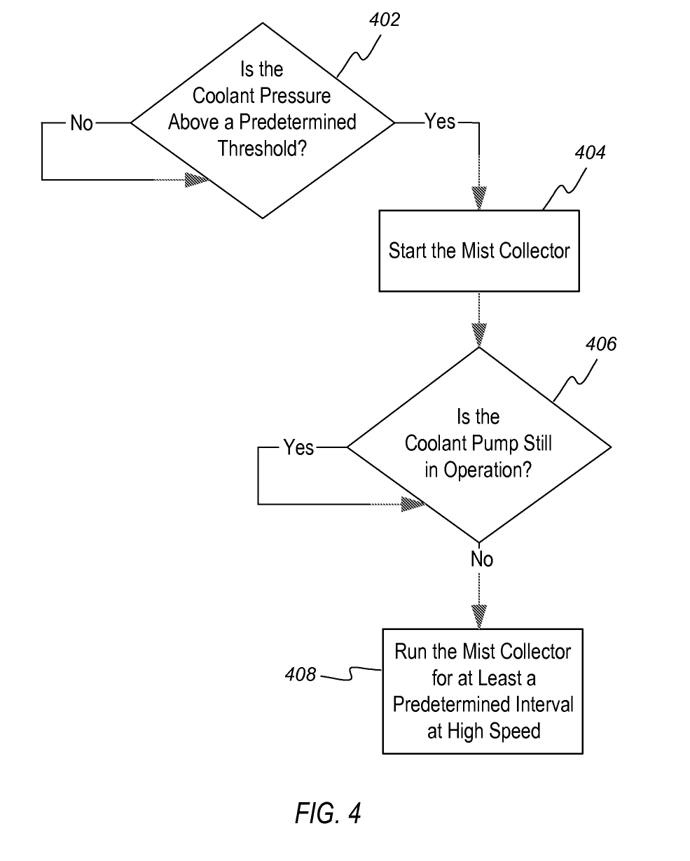

FIG. 4 is a flow chart illustrating a method 400 of controlling a mist collector. One of skill in the art will appreciate that the method 400 can be used by the automatic control 300 of FIG. 3; however, the method 400 can be used by an automatic control other than the automatic control 300 of FIG. 3.

FIG. 4 shows that the method 400 can include determining 402 whether the coolant pressure is above a predetermined threshold. The predetermined threshold can include any desired amount. For example, the predetermined threshold can used to indicate that coolant is actually flowing to the machine tool. Although pressure is used as exemplary herein, one of skill in the art will appreciate that some other quantity can be measured to determine operation. For example, voltage, current, flow or any other indicator can be used to indicate that operation of the mist collector is desired.

FIG. 4 also shows that the method 400 can include starting 404 the mist collector if the coolant pressure is above the predetermined threshold. I.e., if the cooling liquid is being pumped, the automatic control can begin operation of the mist collector. In particular, the automatic control can turn on the fan in the mist collector.

FIG. 4 further shows that the method 400 can include determining 406 whether the coolant pump is still in operation. I.e., determining 406 if the coolant pump continuing to supply cooling liquid to the machine tool. If the coolant pump is still in operation then the automatic control remains in operation. That is, the status quo is maintained.

FIG. 4 additionally shows that the method 400 can include running 408 the mist collector for a predetermined interval at high speed if the coolant pump ceases operation. The predetermined interval can be based on the minimum time to effectively collect the coolant mist. I.e., the mist collector can remain in operation for a set amount of time after the coolant pump ceases operation to ensure that a majority of coolant is collected. For example, the mist collector can run at a high speed for a timed amount preselected to ensure removal of the coolant mist.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

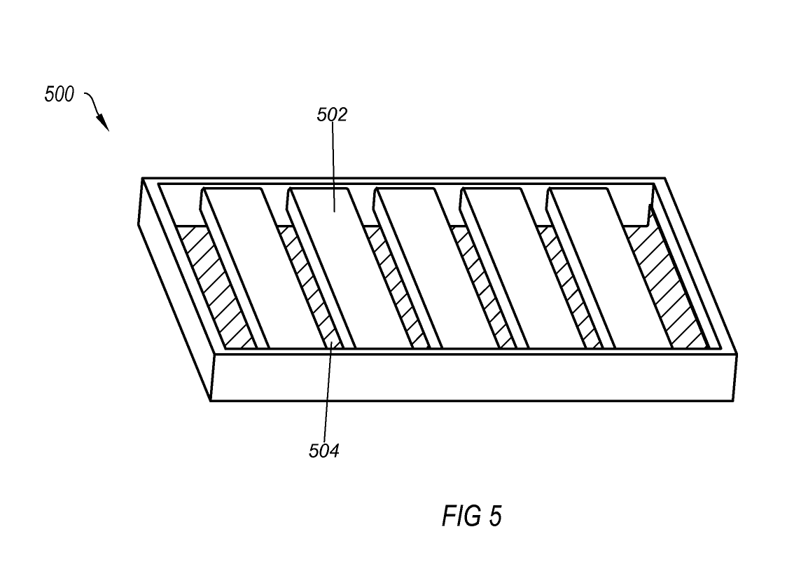

FIG. 5 illustrates an example of a baffle filter 500. The baffle filter 500 can be used to collect large cooling mist droplets. For example, the baffle filter 200 can prevent straight line movement of the cooling mist. As the cooling mist comes in contact with the baffle filter 500 the cooling liquid condenses and is removed from the air.

FIG. 5 shows that the baffle filter 500 can include a first layer of baffles 502. The first layer of baffles 502 are flow-directing or obstructing vanes or panels used to direct air flow through the baffle filter 500. I.e., the first layer of baffles can include panels which cover a portion of the opening in which the baffle filter is placed.

FIG. 5 also shows that the baffle filter 500 can include a second layer of baffles 504. The second layer of baffles 504 can be offset relative to the first layer of baffles 502. Offsetting the second layer of baffles 504 relative to the second layer of baffles 502 can ensure that much of the air flow passes near either the first layer of baffles 502 or the second layer of baffles 504. The closer the air flow passes to either the first layer of baffles 502 or the second layer of baffles 504 the more the cooling liquid will condense out of the air.

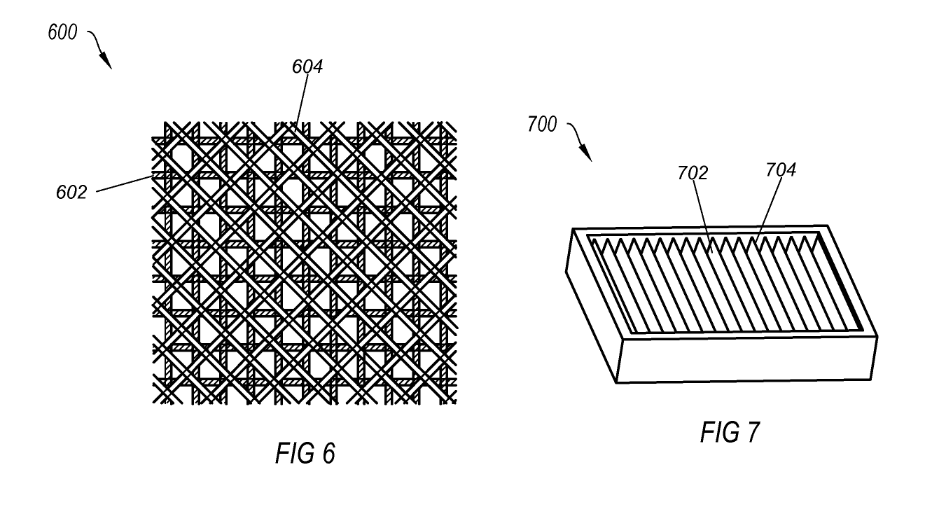

FIG. 6 illustrates an expanded view of an example of a mesh filter 600. The mesh filter 600 can be used to collect smaller cooling liquid droplets. For example, the mesh filter 600 can include small openings through which the cooling mist will flow. As the cooling mist comes in contact with the mesh filter 600 the remaining cooling liquid is removed from the air.

FIG. 6 shows that the mesh filter 600 can include a first layer of mesh 602. The first layer of mesh 602 can include small openings through which the cooling mist can pass. I.e., the first layer of mesh 602 includes much smaller openings that the openings of a baffle filter, as disclosed above. Therefore, the cooling mist passes closer to the first layer of mesh 602 and smaller cooling liquid droplets can be collected.

FIG. 6 also show that the mesh filter 600 can include a second layer of mesh 604. The second layer of mesh 604 can be offset relative to the first layer of mesh 602. Additionally or alternatively, the second layer of mesh 604 can be rotated relative to the first layer of mesh 602. Both offsetting the second layer of mesh 604 and rotating the second layer of mesh 604 relative to the first layer of mesh 602 can decrease the size of the opening through which the cooling mist will pass and, therefore, increase the amount of cooling liquid removed from the air.

FIG. 7 illustrates an example of an air filter 700. The air filter 700 can remove one or more pollutants from the air. In particular, the air filter 700 can remove undesired particles from the air. The filtered air can be more suitable for breathing than unfiltered air.

FIG. 7 shows that the air filter 700 can include a filter material 702. The filter material 702 can include any material which will remove the desired particles from the air. For example, the filter material 702 can include fibrous material such as cotton, foam, cloth, paper, fiberglass or any other desired material. Fibrous material can increase the surface area of the filter material 702, increasing the filtering ability and decreasing the required width of the air filter 700.

FIG. 7 also shows that the air filter 700 can include one or more pleats 704. A pleat 704 (older plait) is a type of fold formed by doubling fabric back upon itself and securing it in place. I.e., a pleat 704 is a fold in the fabric where a surface is folded back to a point where it nearly touches itself. Providing one or more pleats 704 in the air filter can increase the surface area of the filter material 702, thus increasing the filtering capability of the air filter 700.

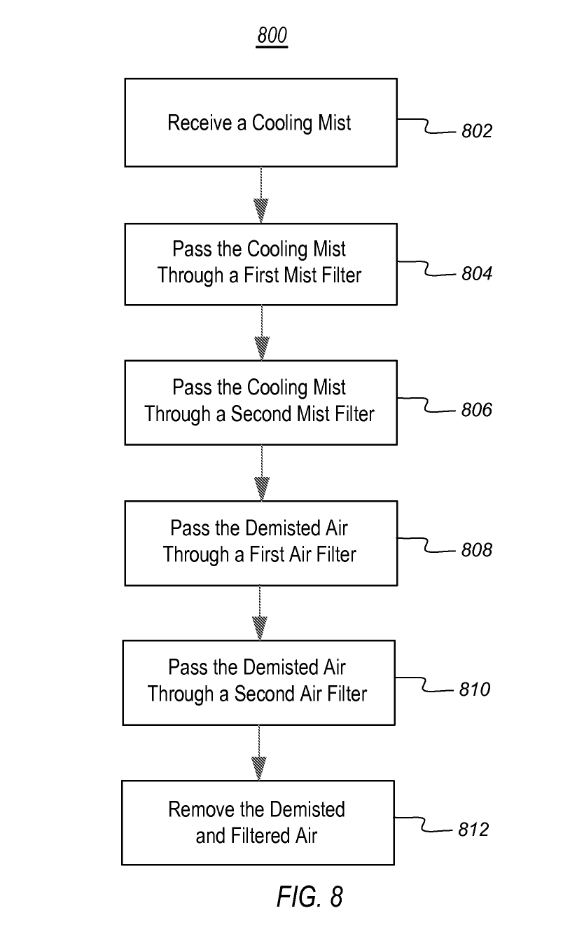

FIG. 8 is a flow chart illustrating a method 800 of removing a cooling liquid from a cooling mist. The method 800 can be performed by a mist collector, such as the mist collector 100 and other components of FIGS. 1-7. Therefore, the method 800 will be described, exemplarily, with reference to the mist collector 100 and other components of FIGS. 1-7. Nevertheless, one of skill in the art can appreciate that the method 800 can be used with a mist collector other the mist collector 100 and other components of FIGS. 1-7.

FIG. 8 shows that the method 800 can include receiving 802 a cooling mist 802. In particular, many tools use a cooling liquid that is applied to either the work surface or some portion of the tool. The cooling liquid is configured to remove the heat caused by friction during the machining process. The machining process can, in turn, throw droplets of the cooling liquid into the air, creating a mist. For example, the cooling liquid can include water, antifreeze, oils, water soluble oil or any other desired cooling liquid.

Receiving 802 a cooling mist can include bringing a cooling mist in through an intake 108. The intake 108 can allow cooling mist to enter the housing 102. I.e., the intake 108 can pull cooling mist into the housing, where the cooling liquid will be removed from the cooling mist. Additionally or alternatively, the collected cooling liquid can pass back through the intake 108 to be used again by the machine tool.

FIG. 8 also shows that the method 800 can include passing 804 the cooling mist through a first mist filter. The first mist filter 202 can include any desired material. For example, the first mist filter 202 can include plastic or metal. The first mist filter 202 can collect larger mist particles. I.e., the first mist filter 202 can collect large droplets from the cooling mist. For example, the first mist filter 202 can include a baffle filter. A baffle filter can include a series of baffles that the cooling mist must pass through. Because there is not a straight line through the filter, larger particles are unable to make the turns required by the air flow and collects on the baffles.

The first mist filter 202 can be inclined relative to a horizontal position. Inclining the first mist filter 202 can allow the larger droplets which have been collect to travel down the filter, where they are collected and reused as cooling liquid for the machine tool.

A fan 212 can be used to pass 804 the cooling mist through a first mist filter. I.e., the fan 212 creates an air flow that draws cooling mist into the mist collector 100 through the first mist filter 202, the second mist filter 204, the first air filter 208, the second air filter 210 and out the exhaust 110.

FIG. 8 further shows that the method 800 can include passing 806 the cooling mist through a second mist filter. The second mist filter 204 can include any desired material. For example, the second mist filter 204 can include plastic or metal. The second mist filter can collect smaller mist particles. I.e., particles which are small enough to remain in the air flow and pass through the first mist filter 202 are collected by the second mist filter 204. The second mist filter 204 can be inclined similar to the first mist filter 202, allowing the collected cooling liquid to drain. Additionally or alternatively, the second mist filter 204 can be horizontal. Any droplets collected can form drops where collected which are allowed to drip onto the first mist filter 202 then collected and returned to the machine tool.

The second mist filter 204 can include any filter configured to receive smaller mist droplets. For example, the second mist filter 204 can include a mesh filter. A mesh filter can include one or more mesh layers. Mesh consists of semi-permeable barrier made of connected strands of material. I.e., mesh includes material with very small openings. As the cooling mist passes through the mesh filter, the cooling mist collects on the strands of material. Mesh layers can be offset relative to one another, eliminating straight lines of air flow. The more mesh layers present, the more droplets collected and the less droplets allowed to pass through the mesh filter; however, more mesh layers decrease the air flow through the mesh filter increasing the required pressure to circulate the cooling mist.

FIG. 8 additionally shows that the method 800 can include passing 808 the demisted air through a first air filter. The first air filter 208 can be configured to remove one or more pollutants from the air. For example, the first air filter 208 can include a carbon filter. Carbon filtering is a method of filtering that uses a piece of activated carbon to remove contaminants and impurities, utilizing chemical adsorption. Activated carbon, also called activated charcoal, activated coal or carbo activatus, is a form of carbon that has been processed to make it extremely porous and thus to have a very large surface area available for adsorption. One pound (454 g) of activated carbon contains a surface area of approximately 100 acres. A carbon filter can be utilized to remove odors from the demisted air.

FIG. 8 also shows that the method 800 can include passing 810 the demisted air through a second air filter. The second air filter 210 can remove additional air pollutants. For example, the second air filter 210 can include a particulate air filter. A particulate air filter is a device composed of fibrous materials which removes solid particulates such as dust, pollen, mold, and bacteria from the air. A particulate air filter can include foam, pleated paper, cotton, cloth or spun fiberglass filter elements. Additionally or alternatively, the second air filter 210 can include an ionizing filter. An ionizing filter, or ioniser, uses fibers or elements with a static electric charge, which attract dust particles.

One of skill in the art will appreciate that the first air filter and the second air filter can be combined with one another. For example, an ionizing filter may be able to remove both odor particles and larger particles from the air. Additionally or alternatively, the number of filters may be increased as needed to remove other pollutants or particles from the air.

FIG. 8 further shows that the method 800 can include removing 812 the demisted and filtered air. For example, the demisted and filtered air can be removed 812 through an exhaust 110. The exhaust 110 can allow clean air to exit the mist collector 100. I.e., the mist collector 100 will take in cooling mist through the intake 108, and pump out clean air, with the cooling liquid removed, through the exhaust 110. The exhaust 110 can connect to the machine tool, can be vented to the outdoors, or can be vented into the tool room, as desired by the user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An automatic control for a system for removing cooling liquid from a mist, the automatic control comprising:
a power input configured to receive electrical power;
a power output configured to output electrical power to a mist collector;
a sensor configured to determine whether a coolant pump is supplying cooling liquid; and
a switch configured to send electrical power to the mist collector via the power output when the coolant pump is supplying cooling liquid.

2. The system of claim 1, wherein the sensor includes:
a coolant flow sensor, configured to measure the flow of cooling liquid from the coolant pump.

3. The system of claim 1, wherein the sensor includes:
a current sensor, configured to measure the draw of electrical power by the coolant pump.

4. The system of claim 1, wherein the automatic control includes:
a coolant pressure sensor, configured to measure the flow of cooling liquid from the coolant pump.

5. The system of claim 1 further comprising:
a speed control circuit, wherein the speed control circuit controls the speed of a fan in the mist collector.

6. The system of claim 5, wherein the speed control circuit allows a user to control the speed of the fan.

7. The system of claim 5, wherein the speed control circuit automatically increases the fan speed if coolant flow increases.

8. The system of claim 1 further comprising a timer.

9. The system of claim 8, wherein the timer is configured to continue operation of the mist collector for a predetermined interval after the flow of cooling liquid from the coolant pump has ceased.

10. The system of claim 9, wherein the fan speed is set to its highest speed for the duration of the predetermined interval.

11. A system for removing cooling liquid from a mist, the system comprising:
a housing;
a fan, wherein the fan is configured to move air through the system;
an intake, wherein the intake is configured to allow a cooling mist from the exterior of the housing to enter the interior of the housing;
wherein the cooling mist includes cooling liquid droplets suspended in air;
a mist filter, wherein the mist filter:
is configured to remove the cooling liquid from the mist; and
includes:
a first mist filter, wherein the first mist filter is configured to remove a portion of the cooling liquid from the cooling mist; and
a second mist filter, wherein the second mist filter is configured to remove the majority of the remaining cooling liquid from the cooling mist;
an air filter, wherein the air filter includes:
a first air filter, wherein the first air filter is configured to remove a portion of pollutants from the demisted air; and
a second air filter, wherein the second air filter is configured to remove a portion of the pollutants not removed by the first air filter;
an exhaust, wherein the exhaust is configured to output the demisted air; and
an automatic control, wherein the automatic control is configured to control the operation of the fan, wherein the automatic control includes:
a power input configured to receive electrical power;
a power output configured to output electrical power to the mist collector;
a sensor configured to determine whether a coolant pump is supplying cooling liquid; and
a switch configured to send electrical power to the mist collector via the power output when the coolant pump is supplying cooling liquid.

12. The system of claim 11 further comprising:
a machine tool, wherein the machine tool uses the cooling liquid to reduce frictional heat of one or more parts of the machine tool.

13. The system of claim 11, wherein the first mist filter includes a metallic baffle filter.

14. The system of claim 11, wherein the second mist filter includes a metallic mesh filter.

15. The system of claim 11, wherein the first air filter includes a carbon filter.

16. The system of claim 11, wherein the second air filter includes a pleated air filter.

17. The system of claim 11, wherein the first mist filter is inclined relative to a horizontal position.

18. A method for removing cooling liquid from a cooling mist, the method comprising:
controlling the operation of the system using an automatic control, wherein the automatic control includes:
a power input configured to receive electrical power;
a power output configured to output electrical power to a mist collector;
a sensor configured to determine whether a coolant pump is supplying cooling liquid; and
a switch configured to send electrical power to the mist collector via the power output when the coolant pump is supplying cooling liquid;
receiving a cooling mist, wherein the cooling mist includes cooling liquid droplets suspended in air;
passing the cooling mist through a mist filter, wherein the mist filter removes a portion of the cooling liquid droplets from the air;
passing the demisted air through an air filter, wherein the air filter removes a portion of a desired pollutant from the demisted air; and
outputting the demisted and filtered air.

19. The method of claim 18, wherein passing the cooling mist through a mist filter includes:
passing the cooling mist through a first mist filter, wherein the first mist filter is configured to remove a portion of the cooling liquid from the cooling mist; and
passing the cooling mist through a second mist filter, wherein the second mist filter is configured to remove the majority of the remaining cooling liquid from the cooling mist.

20. The method of claim 18, wherein passing the demisted air through includes:
passing the demisted air through a first air filter, wherein the first air filter is configured to remove a portion of pollutants from the demisted air; and
passing the demisted air through a second air filter, wherein the second air filter is configured to remove a portion of the pollutants not removed by the first air filter.
